(19) United States
(12) Patent Application Publication
(10) Pub. No.: US 2024/0286086 A1
(43) Pub. Date: Aug. 29, 2024

(54) COMPOSITE MATERIAL FOR MECHANICAL FILTRATION AND CHEMICAL BINDING OF SUBSTANCES, BACTERIA AND VIRUSES FROM SOLUTIONS

(71) Applicant: INSTRACTION GmbH, Heidelberg (DE)

(72) Inventors: Martin WELTER, Neckargemuend (DE); Christian MEYER, Schwetzingen (DE); Kristian LUNGFIEL, Neueibau (DE)

(73) Assignee: INSTRACTION GmbH, Heidelberg (DE)

(21) Appl. No.: 18/574,373

(22) PCT Filed: Jun. 23, 2022
(86) PCT No.: PCT/EP2022/067097

§ 371 Date: Dec. 27, 2023

(30) Foreign Application Priority Data
Jun. 28, 2021 (DE) 10 2021 116 595.4

(51) Int. Cl. B01D 69/02; B01D 69/08; B01D 69/14; B01D 71/44; B01D 71/68

(52) U.S. Cl. CPC B01D 69/02; B01D 69/08; B01D 69/147; B01D 71/44; B01D 71/68; B01D 2325/022; B01D 2325/12

(57) ABSTRACT

The present invention relates to a composite material which is suitable both for mechanical filtration and for chemical/selective binding/rejection/exclusion of substances from solutions. Furthermore, the present invention relates to the use of the composite material as a filtration membrane. The present invention is thus also directed to a filtration membrane comprising a composite material according to the invention, such as the use of the filtration membrane for the purification of liquids and/or for the separation of substances from liquids and/or for the removal of bacteria or viruses from liquids.

The present invention relates to a composite material which is suitable both for mechanical filtration and for chemical/selective binding/rejection/exclusion of substances from liquids/solutions. Furthermore, the present invention relates to the use of the composite material as a filtration membrane. The present invention is thus also directed to a filtration membrane comprising a composite material according to the invention, such as the use of the filtration membrane for the purification of liquids and/or for the separation of substances from liquids and/or for the removal of bacteria or viruses from liquids.

The removal, extraction or recovery of metals, especially heavy metals, or organic substances, such as steroids or antibiotics, from liquids such as industrial wastewater, for example from galvanic operations, from catalyst residues from the petrochemical or pharmaceutical industry, from mine water, for example from mines, the renaturation of soils contaminated with heavy metals, etc. is an increasingly important task.

The reason for this is the damaging effect of these substances on the environment. However, the recovery of metals in particular also represents an economic interest. This means that, on the one hand, environmental aspects are in the foreground and, on the other hand, the provision of valuable metals, whose availability is increasingly questionable or whose price is rising, is also of great interest. Another important field of application of materials for the removal, extraction or recovery of metals or heavy metals is the separation of these in drinking water treatment and in seawater desalination.

The separation of heavy metals from concentrated salt solutions, as used in chlor-alkali electrolysis or similar processes, is also of great interest.

A number of different methods with different objectives are currently used to extract metals from aqueous solutions:

The most common method is the precipitation of metals by shifting the pH value to a range in which metals no longer dissolve. This method requires the addition of precipitants and flocculants and results in an amorphous precipitate with a very low content of metals, which are present in undefined, highly fluctuating mixtures. As a rule, these sludges are sent for final disposal and are no longer suitable for further use.

In some cases, a type of classic separation process is carried out on an industrial scale, in which precipitates are produced that have to be broken down again and again and subjected to further purification steps.

The removal of metals that are only present in low concentrations is either not possible in this way (equilibrium constants, solubility) or uneconomical. Separation of individual metal elements is not possible with the process currently used.

In alternative processes, ion exchangers or other adsorber resins are used, which are characterized by low capacity, poor stability and a long service life. They have hardly any selectivity and are unsuitable for recycling metals from low-concentration solutions. At the same time, the binding of the most valuable metals is severely disrupted by unproblematic salts such as sodium chloride. The binding mechanism of the phases mentioned is based on simple ion exchange, with all the serious disadvantages, such as interference from organic components, low capacity, sensitivity to other ionic admixtures, short service life, degradation, low or no selectivity and lack of sanitizability or recoverability.

There are a few suppliers of phases whose binding behavior is based on complex formation. The phases known to date are used in the pre-treatment of pre-purified solutions in chlor-alkali electrolysis but are unsuitable for the intended areas of application due to their complex production method and sensitive structure. They also have a comparatively low capacity. At the same time, only low volume flows can be processed using this method. In addition to the inability to capture metals even in low concentrations, the lack of throughput is currently the main obstacle to the introduction of such methods.

Others, such as electrochemical membrane processes, are very energy-intensive and are only suitable for the extraction of secondary raw materials from sources that are already very clean. These processes are therefore unsuitable for the treatment of contaminated wastewater.

In addition to the heavy metals mentioned above, the removal of bacteria and viruses from drinking water is a task of increasing importance. Membranes are used here that mechanically remove bacteria from water due to their pore structure. Viruses are usually not removed due to their small size. The purely mechanical removal of bacteria subsequently leads to the formation of a biofilm, in which the bacteria continue to grow and can contaminate the water. As a rule, the bacteria grow through the membrane in a short period of time, so that permanent use is not possible despite frequent backwashing.

The addition of toxic chemicals, such as chlorination or the addition of antibiotics, treatment with ozone or irradiation with UV light, is another known method of killing germs. The disadvantage of these methods is either that toxic chemicals are added, which either impair the taste of the water and have to be laboriously removed, or cause undesirable side effects such as the promotion of antibiotic resistance.

Furthermore, some of the methods mentioned are very energy-intensive or not very effective overall.

Thus, the present invention is based on the task of removing or killing bacteria and viruses from solutions and binding at least some of the resulting fragments.

In addition to heavy metals, bacteria and viruses, micropollutants such as per-fluorinated surfactants represent a challenge that is becoming increasingly important. Per-fluorinated surfactants are released into the environment from washing solutions for outdoor clothing or industrial processes and are practically not degraded there. As a result, they accumulate in the environment and, over time, enter the human and animal food cycle via food, where they can cause corresponding damage.

The present invention therefore additionally sets itself the task of quickly and effectively removing micropollutants, such as per-fluorinated surfactants, from water or other solvents.

The disadvantages of the established procedures are summarized below:
low capacity
No or insufficient selectivity
no tolerance to highly concentrated accompanying substances
Low stability and service life
High energy consumption
Low throughputs
Not applicable to low concentrated solutions
difficult reuse
Complex pre-cleaning processes required
Multi-stage separation process with repeated precipitation and digestion stages

In addition to the chemical or selective binding, rejection or exclusion of metals and other substances as impurities, it would also be advantageous if, in addition to this cleaning mode, purely mechanical filtration of the liquids to be cleaned were possible simultaneously. In this way, particulate impurities or aggregates can be separated from liquids by purely mechanical filtration and, in addition, smaller components of the liquids to be purified that are not separated by filtration can be removed from the liquids by chemical or selective absorption, rejection or digestion of substances. To date, porous membrane materials are known for this purpose, into which polymer microgel particles produced in advance are introduced. The pre-production of the polymer microgel results in a specific particle size of the gel. Due to the corresponding particle size, these can only be introduced into pores of a membrane material or its support structure that are large enough to accommodate the microgel particles. This has the disadvantage that in the corresponding systems large parts of the pore volume are not filled with the microgel, so that the chemical absorption performance of such systems is not satisfactory. Furthermore, the already known membrane materials with microgel particles in the pores of the support structure are usually materials that change their separation properties or absorption properties greatly depending on the temperature or whose capacity fluctuates greatly depending on the temperature. This is also not desirable.

It was therefore the task of the present invention to provide a composite material with which the advantages of mechanical filtration and chemical or selective binding/rejection/exclusion of substances can be effectively combined or made possible simultaneously, so that metals or substances can also be removed from dilute and concentrated aqueous and non-aqueous, acidic, basic or neutral solutions. Furthermore, it was also a task of the present invention to remove metals or heavy metals from solutions with a simultaneously high alkali metal load.

In addition, killing bacteria and viruses and removing certain micropollutants, such as perfluorinated surfactants, is part of the problem to be solved.

Preferably, the composite material provided according to the invention is sanitizable or allows the recovery of the absorbed metals or organic substances in a simple manner, as well as the effective cleaning of the composite material under correspondingly drastic conditions.

Furthermore, the present invention aims to provide a composite material with which large volume flows with moderate heavy metal contamination can be processed within a short time and sterilization/filtration is desired.

The problem of the present invention is solved by providing a composite material according to the invention comprising an organic polymer and a layered material having a pore system with open pores, wherein the open pores extend continuously through the layered material, and wherein the open pores on a first side of the layered material have a smaller average pore size than on a second side, the first and second sides being opposite sides of the layered material, characterized in that the organic polymer is located in the open pores, wherein the organic polymer is introduced into the pore system from homogeneous solution and subsequently immobilized.

The first side and the second side of the layered material are opposite, outer sides of the layered material, i.e. opposite surfaces of the layered material. The vector of the extension of the first and the second side of the layered material lies in the direction of extension of the layered material and is arranged at a right angle to the vector of the thickness of the layered material. This arrangement of the layered material thus permits flat membranes as well as cylindrical membranes, which are preferred here.

Because the layered material has a smaller average pore size on the first side than on the second side of the layered material, this side can take on the function of a filtration membrane, in which substances or particulate impurities can be filtered out of liquids flowing through the layered material by purely mechanical filtration and size exclusion. Due to the larger average pore size on the second side of the layered material, an organic polymer can be introduced into the pores of the pore system, which performs the function of chemical/selective absorption/bonding/rejection/exclusion of substances.

Characterization using dextran standards (similar to inverse size exclusion chromatography) is used to determine the pore size on the first side of the layered material (membrane side):

Different solutions of dextrans with a defined, increasing molecular mass are flushed through the layered material from the first to the second side. The size cut-off of the layered material is determined by the width of the pores: if the size of the dextran standards continues to increase, at some point a size is reached at which the layered material no longer passes through (MWCO: Molecular Weight Cut Off). In this way, the pore size on the first side of the layered material can be determined. The size of the remaining pores (in particular the pore size on the second side of the layered material) can now be determined comparatively using SEM images (SEM: scanning electron microscope). Alternatively, the average pore sizes on the first and second side can also be determined in absolute terms using the SEM alone by taking and analyzing SEM images of both sides of the layered material. The increase in the pore size of the material from the first to the second side of the layered material can be shown by an SEM image of the cross-section.

The organic polymer which is introduced into the pore system of the layered material preferably has the property that it is a polymer capable of chemical/selective absorption or repulsion, i.e. an absorption polymer. The organic polymer is preferably a hydrophilic polymer. If the composite material is used for cleaning liquids, the flow direction of the liquid is preferably from the first to the second side of the layered material. If the organic polymer is a hydrophilic polymer, the more hydrophilic surface of the layered material leads to a simplification of the elution of lipophilic residues that are retained due to the size exclusion of the membrane, which contributes to an improvement of the antifouling properties of the membrane. This leads to a higher productivity of the membrane as the backwash cycles and the backwash volumes used are reduced.

By introducing the organic polymer, preferably a linear polymer, from a homogeneous solution in which the polymer is dissolved, into the pore system, smaller pores can also be coated or filled with the organic polymer than if the polymer is already present in the form of hydrogel/microgel particles before introduction. In this way, a significantly more homogeneous coating or filling of the pores or the surfaces of the pores is achieved, which results in an increase in capacity.

The subsequent immobilization of the polymer introduced into the pore system is intended to bind the organic polymer to the layered material. Immobilization can be achieved by cross-linking the organic polymer introduced into the pore system. However, the immobilization or fixation of the polymer can also take place by covalent bonding of the organic polymer to the layered carrier material. A further possibility according to the invention is also the immobilization/fixation of the organic polymer to the layered carrier material by adsorptive and/or ionic interactions.

If the organic polymer is to be immobilized/fixed by crosslinking, this can be carried out with a crosslinking agent which is either applied after the organic polymer has been introduced into the pore system, or is introduced together with the organic polymer, or is already present in the pore system beforehand. In the latter case, the crosslinking agent is preferably applied to the layered material by drying, in that the crosslinking agent dissolved in a solvent is introduced into the pore structure of the layered material and the solvent is subsequently removed by evaporation, as a result of which the crosslinking agent is present on the surface of the pores. Subsequently, the organic polymer to be crosslinked is introduced into the pore structure by the methods described herein and can react with the crosslinking agent to form a crosslinked polymer.

If the organic polymer is immobilized/fixed by crosslinking, it then preferably has a degree of crosslinking of at least 2%, based on the total number of crosslinkable groups in the organic polymer. More preferably, the degree of crosslinking is in the range from 2.5 to 60%, more preferably in the range from 5 to 50% and most preferably in the range from 10 to 40%, in each case based on the total number of crosslinkable groups in the organic polymer. The degree of crosslinking can be adjusted by the corresponding desired amount of crosslinking agent. It is assumed that 100 mol % of the crosslinking agent reacts and forms crosslinks. This can be verified by analytical methods such as MAS-NMR spectroscopy and quantitative determination of the amount of crosslinking agent in relation to the amount of polymer used. This method is preferable according to the invention. The degree of crosslinking can also be determined by IR spectroscopy in relation to C—O—C or OH vibrations, for example, using a calibration curve. Both methods are standard analytical methods for a person skilled in the art. If the degree of crosslinking is above the specified upper limit, the polymer coating or filling of the organic polymer is not flexible enough and results in a lower bonding capacity. If the degree of cross-linking is below the specified lower limit, the polymer coating is not sufficiently stable on the surface or in the pores of the layered material.

The crosslinking agent has two, three or more functional groups, through the bonding of which to the organic polymer the crosslinking takes place. The crosslinking agent used to crosslink the organic polymer is preferably selected from the group consisting of dicarboxylic acids, tricarboxylic acids, aldehydes, urea, bis-epoxides or tris-epoxides, diisocyanates or triisocyanates, and dihaloalkyls, trihaloalkyls or mixed functional molecules (e.g. epichlorohydrin), dicarboxylic acids and bis-epoxides being the preferred functional groups. The crosslinking agent consists of dicarboxylic acids and bis-epoxides, such as terephthalic acid, biphenyldicarboxylic acid, ethylene glycol diglycidyl ether and 1,12-bis-(5-norbornene-2,3-dicarboximido)-decanedicarboxylic acid, the latter two being more preferred. In one embodiment of the present invention, the crosslinking agent is preferably a linear, conformationally flexible molecule having a length of between 3 and 20 atoms.

The preferred molecular weight of the organic polymer is preferably in the range of 5,000 to 5,000,000 g/mol.

If the organic polymer is immobilized/fixed to the layered material by covalent bonding, functional side groups of the polymer are preferably made to react with functional surface groups of the layered material, or are made to react with a reactant after the organic polymer has been introduced into the pore system of the layered material. Functional surface groups of the layered material can be aliphatic or benzylic C atoms, which are activated by bromination, for example. Functional side groups of the organic polymer can, for example, be nucleophilic groups such as —OH or amino groups, which can then be linked to the functional surface groups of the layered material.

If the organic polymer is immobilized/fixed to the layered material by adsorptive or ionic interaction, the organic polymer preferably has an ionic group in the side chain that has a complementary charge to an ionic group on the surface in the pores of the layered material. Such complementary ionic groups can be, for example, —SO₃⁻ and —NH₃⁺.

The organic polymer can be a polymer consisting of the same repeating units (polymerized monomers), but it can also be a co-polymer, which preferably has simple alkene monomers or polar, inert monomers such as vinylpyrrolidone as co-monomers.

Examples of the organic polymer introduced into the pore system from homogeneous solution are polyalcohols, polyamines, such as any polyalkylamines, e.g. polyvinylamine and polyallylamine, polyethyleneimine, polylysine, the amino group-containing polymers available under the trade name lupamine, etc. Among these, polyalkylamines and polyalkyl alcohols with hydroxyl or amino groups are preferred, and polyvinylamine, polyallylamine and lupamine are even more preferred, with polvinylamine and lupamine being particularly preferred.

After the organic polymer has been introduced into the pore system of the layered carrier material and subsequently immobilized, the polymer is preferably in the form of a so-called hydrogel. In the present case, a hydrogel is understood to be a solvent (preferably water) containing but solvent-soluble polymer whose molecules are linked chemically, e.g. by covalent or ionic bonds, or physically, e.g. by entanglement of the polymer chains, to form a three-dimensional network. Due to incorporated polar (preferably hydrophilic) polymer components, they swell in the solvent (preferably water) with a considerable increase in volume (depending on the cross-linking), but without losing their material cohesion. The organic polymer introduced into the pore system of the layered material is present as a hydrogel in the composite material according to the invention in particular when the latter is swollen in a solvent, i.e. in particular during the use of the composite material described below.

The use of a polymer containing hydroxyl or amino groups as an organic polymer also has the advantage that organic residues can be introduced into the side chain of the polymer at the oxygen or nitrogen of the hydroxyl or amino groups, which can form specific interactions with substances or heavy metals to be purified. Such organic residues are preferably residues with Lewis base properties. In this way, functionalization of the organic polymer can take place, which preferably only occurs after immobilization of the organic polymer in the pore structure of the layered material.

Polymers containing amino groups also have the advantage of having an anti-microbial effect (DE102017007273A1) and are therefore able to not only remove bacteria and viruses due to size exclusion, but also kill them directly.

The organic polymer is introduced into the pore system by producing a homogeneous solution of the organic polymer, which is then introduced into the pore system. This can be done by known wet-chemical impregnation processes but can also be realized by a so-called flow-through process, in which the solution containing the organic polymer is pumped through the composite material.

Dip coating and the pore filling method are known as wet chemical impregnation processes. In dip coating, the layered material is immersed in the homogeneous solution of the organic polymer for a given period of time and the pore space is filled with this solution by capillary force. Both pure water or aqueous media and organic solvents such as dimethylformamide can be used as solvents.

The layered material can be composed of a single or multiple layers. By “a single layer” of the layered material is meant a layered material in which the components leading to the first and second sides consist of the same material apart from the pore size. In this case, the average pore size can increase continuously, but also abruptly, from the first side of the layered material to the second opposite side of the layered material by joining two layers of the same material with different average pore sizes in the latter case. The term “two or more layers” of the layered material refers to two different layers made of different materials, of which the material on the first side has a smaller average pore size than the material on the opposite second side. Here too, the pore size can increase abruptly or continuously.

The component of the layered material which is located on the first side with a small average pore size can also be referred to as membrane material, since due to its smaller pore size this material is preferably responsible for the mechanical filtration in the application of the composite material. In other words, the component on the first side of the layered material constitutes a membrane. This first side can thus also be referred to as the membrane side.

The component of the layered material which gives rise to the larger average pore size on its second side can also be referred to as the so-called support structure for the component on the first side (membrane material) of the layered material. Preferably, the average pore size of the pores on the second side of the layered material is in the range from 6 nm to 20.000 nm, more preferably in the range from 10 nm to 12.000 nm and even more preferably in the range from 20 nm to 5.000 nm.

The layered material preferably has a thickness in the range from 500 μm to 10 cm, more preferably in the range from 600 μm to 5 cm and most preferably 700 μm to 2 cm.

It is further preferred that the average pore size on the first side is at least 3% smaller than the average pore size of the second side, even more preferably at least 7% and even more preferably at least 12%. If the average pore size on the second side is too small, it is difficult to fill the pore system with the organic polymer. Further disadvantages are an increase in the back pressure of the filtration membrane, low permeability, high backwash frequency and limited regenerability.

Regardless of whether the layered material is composed of one or more layers, each of these layers may independently be a cross-linked organic polymer, an inorganic material or a mixture thereof.

Suitable inorganic materials, such as those used here, are also known as monoliths or ceramic membranes or ceramic monoliths and can be flat or hollow cylinders, among other things.

The crosslinked organic polymer is preferably selected from the group consisting of polyalkyl, preferably with an aromatic moiety in the side chain (i.e. bonded to the polyalkyl chain), polyethersulfone, polyacrylate, polymethacrylate, polyacrylamide, polyvinyl alcohol, polysaccharides (e.g. starch, cellulose, cellulose ester, amylose, agarose, sepharose, mannan, xanthan and dextran), and mixtures thereof. Most preferably, the crosslinked organic polymer is a polystyrene or a polyethersulfone, or a derivative thereof, such as a co-polymer of polystyrene and divinylbenzene. If the crosslinked organic polymer carries an aromatic unit, this is preferably present in sulfonated form. In a particularly preferred embodiment of the present invention, the crosslinked organic polymer is a polyether sulfone.

In a further preferred embodiment, polymeric monoliths, porous and also non-porous, made of per-fluorinated polymers are used (e.g. PTFE, TPE, PVF, PVDF, PCTFE or PFA copolymers as well as related polymers and biopolymers made of lignin or cellulose, for example).

If the layer or layers of the layered material are inorganic materials, the inorganic material is preferably an inorganic mineral oxide selected from the group consisting of silicon oxide, aluminum oxide, magnesium oxide, titanium oxide, zirconium oxide, nitrides or carbides of the aforementioned oxides, fluorosil, magnetite, zeolites, silicate (e,g. diatomite), mica, hydroxyapatite, fluoroapatite, organometallic basic structures, ceramics, glass, porous glass (e.g. trisoperl), metals, e.g. aluminum, silicon, iron, titanium, copper, silver and gold, graphite and amorphous carbon. In particular, the inorganic material is preferably one of the above-mentioned mineral oxides, with aluminum oxide and titanium oxide being preferred.

The individual layers or the one layer of the layered material can be (independently of each other) of homogeneous or heterogeneous composition, and therefore also includes in particular materials composed of one or more of the above-mentioned materials.

The layered material can be obtained by a process mentioned in DE 10 2005 032 286 A1, EP 2 008 704 A1, WO 2006/012920 A1, DE 600 16 753 T2 and DE 699 35 893 T2.

In a further embodiment, the present invention also relates to a filtration membrane comprising or consisting of a composite material according to the invention. This filtration membrane can have the form of a flat membrane, a tubular membrane or a hollow fiber membrane, whereby hollow fiber membranes are preferred according to the invention due to the higher throughput, since they enable simpler filtration apparatuses and have a lower fiber breakage compared to flat membranes. In a hollow fiber membrane, the composite material according to the invention is arranged in the form of a tube, in which the first side of the layered material is located inside the tube and the opposite second side represents the outer surface of the tube. Several such tubes can also be arranged next to each other so that an even higher throughput efficiency can be achieved during use. Corresponding hollow fiber membranes are known in the prior art and can be found in the aforementioned publications.

In a further embodiment, the present invention also relates to a process for producing a composite material according to the invention, in which a layered material having a pore system with open pores extending continuously through the layered material is treated with a homogeneous solution of an organic polymer. All the aforementioned process features for producing the composite material according to the invention are thus also part of the process according to the invention. The same also applies to the components mentioned in connection with the composite material according to the invention.

In particular, the present invention also relates to the use of the composite material according to the invention as a filtration membrane.

Furthermore, the present invention also relates to the use of the filtration membrane according to the invention for the purification of liquids and/or for the separation of substances from liquids, preferably suspended, dissolved or colloidal substances. Particularly preferred is the use of the filtration membrane according to the invention for separating metals/metal compounds and/or organic substances from liquids, organic substances being, for example, steroids, antibiotics, etc., which in particular should not get into the groundwater, or whose concentration therein should not exceed certain limit values.

According to the invention, the liquids from which metals/metal compounds and/or organic substances are to be bound can be concentrated or diluted aqueous or non-aqueous, acidic, basic or neutral liquids or solutions.

Metals/metal compounds which are to be separated in the use according to the invention are preferably metals which are present in ionic form or also as metal-ligand coordination compounds in ionic form in the said solutions. The metals are preferably complex-forming metals, i.e. metals which can form a metal-ligand coordination bond. More preferably, the metals are transition metals or rare earth metals, even more preferably noble metals or rare earth metals. The metals copper, nickel, lead and chromium are particularly preferred.

In a further embodiment of the use according to the invention, the liquids from which the metals are to be bound are liquids which should be purified in high volume flows, such as drinking water and surface water.

Furthermore, the liquids from which the metals are to be bound are preferably aqueous solutions with a pH value in the range from 3 to 10, more preferably 5 to 9, and even more preferably 6 to 8.

To bind the metals from liquids, the metal-containing liquids are pumped through the filtration membrane, preferably from the first side to the second side of the layered material. By providing the composite material according to the invention or the filtration membrane according to the invention, not only can chelating metals be removed from a liquid, but they can also be recovered by elution. Since the use of the filtration membrane according to the invention results in a significant concentration on the functionalized membranes of the substance or metal to be purified, manageable volumes are obtained which can be used for further economic processing. This means that the possibility of a circular economy also extends to very large volume flows with a low concentration of valuable heavy metals.

Furthermore, the present invention enables the simultaneous filtration of impurities and chemical removal of organic substances or metals by absorption/complexation. The high-volume flow rate is maintained by using the composite materials according to the invention as filtration membranes.

The main benefit of the present invention is the liberation of wastewater contaminated with low heavy metals with simultaneous ultrafiltration and sterilization, as well as the targeted removal of micropollutants through the use of specially functionalized polymers. The invention thus closes the technical gap that cannot be addressed with particulate chelating gels: with particulate systems (columns, cartridges) there is a significant pressure drop, which significantly limits the throughput of solution volume per unit of time. This means that very large systems are required if particulate absorbers are to be used. This limitation is eliminated in the composite material according to the invention as a filtration membrane: high volume flows can be achieved within a very short time with systems that are much smaller than those that would have to be designed with particulate systems.

Thus, the present invention provides the following advantages:
Combination of mechanical clarification of the water flows and the removal of heavy metals/undesirable substances, as well as sterilization
High volume throughputs of contaminated solutions per time unit and system size
Membrane systems are technically established on a very large scale worldwide
high service life
high mechanical chemical robustness, and
Easier regeneration and recovery of metals.

The present invention will now be explained with reference to the following figures and examples, which are, however, to be regarded only as exemplary:

### ILLUSTRATIONS OF THE FIGURES

FIG. 1 shows a section of a layered material (1) with the first side (2) and the second side (3) opposite the first side.

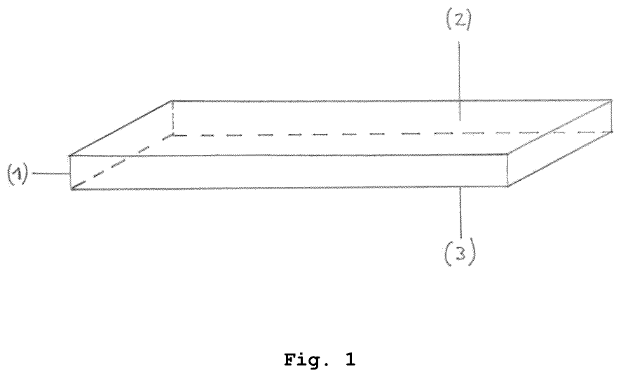

FIG. 2 shows a filtration membrane according to the invention designed as a hollow fiber membrane (4), which is composed of a composite material according to the invention. As can be seen from the reference signs (1), (2) and (3), the side with the smaller average pore size of the composite material is located in the interior of the hollow fiber membrane and the part with the larger average pore size is located on the outer surface.

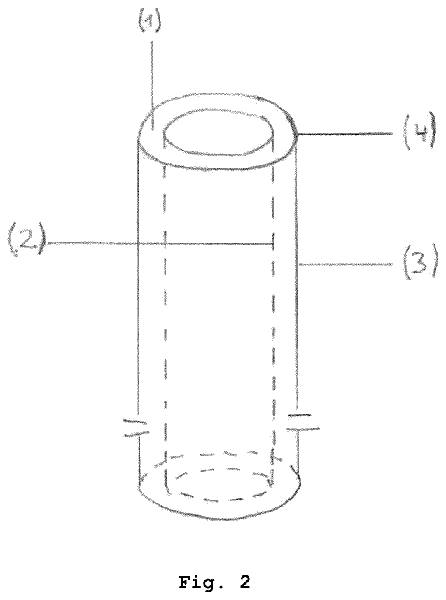

FIG. 3 shows the detection of the effluents of a hollow fiber membrane consisting of a composite material according to the invention according to example 1 in comparison to an uncoated hollow fiber membrane.

FIG. 4 shows a recorded isotherm when testing a hollow fiber membrane consisting of a composite material according to example 2.

### EXAMPLES

### Example 1

Production of a Composite Material According to the Invention in the Form of a Hollow Fiber by the so-Called Flow-Through Process:

A PES hollow fiber (PES: polyethersulfone) with an average pore diameter of 20 nm on the inner side of the hollow fiber and an average pore diameter of 1 μm on the outer side and with an outer diameter of 4 mm and 7 inner channels with a diameter of 900 μm each, which is embedded in a 25 cm long tube, is rinsed with 100 ml of deionized water, methanol and again deionized water to prepare the coating. A solution of 2.0 g hydrolyzed lupamine 4500 (10% m/m) in 50 mL deionized water is then pumped through the fibre. The aqueous solution is then removed from the fiber and the tube by suction and a solution of 100 mg ethylene glycol diglycidyl ether in 100 mL isopropanol is pumped through the fiber. This solution is pumped in a circle, the total volume pumped is 500 mL. After completion, the excess solution is removed by suction and the fiber is rinsed with 50 mL each of isopropanol, methanol, deionized water, 1 mol/L HCl (aq.), deionized water, 1 mol/L NaOH (aq.) and deionized water in this order.

### Example 2

Production of a Composite Material According to the Invention in the Form of a Hollow Fiber by the so-Called Wet-Chemical Coating:

Seven 5 cm long pieces of a PES hollow fiber as in example 1 are washed three times in 100 mL deionized water each and then treated in a solution of 6 g hydrolysed lupamine 4500 (10% m/m) in 150 mL deionized water for 24 h on an overhead shaker. The supernatant solution is then decanted off and the fiber pieces are washed twice with 50 mL isopropanol each time, whereby the supernatant solution is also decanted off. The pieces are now treated in a solution of 300 mg ethylene glycol diglycidyl ether in 100 mL isopropanol for 24 h on an overhead shaker. After completion, the supernatant is discarded and the work-up is carried out by washing with 50 mL each of isopropanol, methanol, deionized water, 1 mol/L HCl (aq.), deionized water, 1 mol/L NaOH (aq.) and deionized water in this order.

### Example 3

### Testing a Composite Material According to Example 1:

A solution of 1 g/l CuSO*5H₄₂ O in water is pumped through a bypass at a flow rate of 1 ml to obtain a baseline. After 10 min, the flow is switched to the hollow fiber membrane according to example 1, which is cast into a single module, by switching the valve. The effluent is detected with UV at 790 nm (absorption copper-aqua complex). As soon as the module is saturated with copper, a breakthrough of the metal occurs, which is detected due to its absorption. The amount of copper absorbed by the membrane is determined by comparison with the corresponding reference surface.

The same is done with a hollow fiber membrane as in example 1, which has not been coated with the polymer according to example 1.

The 1% breakthrough of the coated membrane occurs approx. 10 min later than that of the uncoated membrane. This corresponds to a copper uptake of approx. 40 mg/m membrane. A slower increase is also observed. Both of these results demonstrate the binding of copper from the solution to the coated phase.

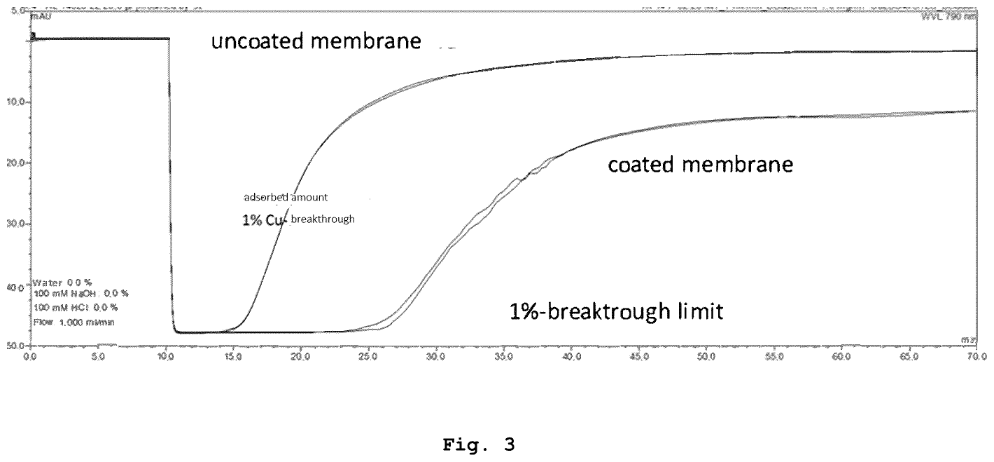

The breakthrough of the uncoated phase occurs when the dead volume of the module is filled (after about 5 min). The detection of the effluents is shown in FIG. 3.

### Example 4

### Testing a Composite Material According to Example 2:

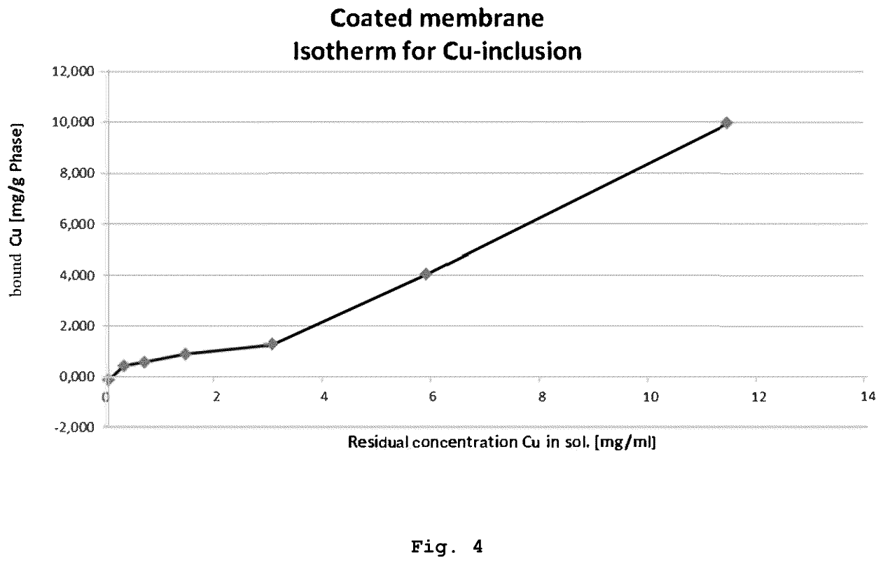

7 pieces of membrane prepared using the same adsorption process (example 2) are incubated with 7 different solutions of increasing copper sulphate concentration for 24 hours. The supernatant is separated and the concentration of unbound copper in solution is determined photometrically at a wavelength of 790 nm. The amount of copper absorbed is calculated and the isotherm determined (FIG. 4). This shows that the coated membrane binds approx. 20 mg/m membrane at the highest concentration tested. The course of the isotherm indicates that the maximum loading has not yet been reached.

### Example 5

### Coating of an Inorganic Monolith

A 10 inch hollow cylinder with a wall thickness of 1 cm made of porous ceramic with an average pore diameter of less than 5 μm is washed with 10 L deionized water in both flow directions and then incubated in a solution of 200 g hydrolysed lupamine 4500 (10% m/m) in 800 mL deionized water for 24 h in a closed vessel on an overhead shaker. The supernatant solution is then decanted and the hollow cylinder is rinsed twice with 2 L isopropanol each time. The hollow cylinder is then treated in a solution of 8 g ethylene glycol diglycidyl ether in 990 mL isopropanol for 24 h on the overhead shaker. After completion, the supernatant is discarded and the work-up is carried out by washing with 5 L each of isopropanol, methanol, deionized water, 1 mol/L HCl (aq.), deionized water, 1 mol/L NaOH (aq.) and deionized water in this order.

1. Composite material comprising an organic polymer and a layered material having a pore system with open pores, wherein the open pores extend continuously through the layered material, and wherein the pores on a first side of the layered material have a smaller average pore size than on a second side opposite the first side, characterized in that the organic polymer is located in the open pores, wherein the organic polymer is introduced into the pore system from homogeneous solution and subsequently immobilized.

2. The composite material according to claim 1, wherein the organic polymer is an absorption polymer.

3. The composite material according to claim 1, wherein the organic polymer is a hydrogel.

4. The composite material according to claim 1, wherein the organic polymer is a hydroxy- or amino group-containing polymer which may contain further organic radicals in the side chain.

5. The composite material according to claim 1, wherein the organic polymer is bound to the composite material by crosslinking and/or covalent bonding, adsorptive bonding and/or ionic bonding.

6. The composite material according to claim 1, wherein the first side has an average pore size, wherein the average pore size of the pores on the first side is in the range of 6 nm to 20,000 nm.

7. The composite material according to claim 1, wherein the first side has an average pore size, wherein the average pore size of the first side is at least 3% smaller than the average pore size of the second side.

8. The composite material according to claim 1, wherein the layered material is composed of one or more layers which may independently be an organic polymer or an inorganic material.

9. The composite material according to claim 1, wherein the layered material is in the form of organic or inorganic monoliths.

10. A method of filtration comprising using a composite material according to claim 1 as a filtration membrane.

11. A filtration membrane comprising a composite material according to claim 1.

12. The filtration membrane according to claim 11, which has a form, wherein the form of the filtration membrane is a flat membrane, a tubular membrane or a hollow fiber membrane.

13. A method for purification comprising using the filtration membrane according to claim 11 for the purification of liquids and/or for the separation of substances from liquids.

14. The method according to claim 13, wherein the substances are metals/metal compounds and/or organic substances.

15. The method according to claim 13, wherein the substances are bacteria or viruses.
